(19) United States
(12) Patent Application Publication
(10) Pub. No.: US 2002/0138377 A1
(43) Pub. Date: Sep. 26, 2002

(54) System and method for providing audit tracking

(76) Inventor: John R. Weber, Lilburn, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/104,628

(22) Filed: Mar. 22, 2002

Related U.S. Application Data
(60) Provisional application No. 60/278,070, filed on Mar. 22, 2001.

(51) Int. Cl. G06F 17/60

(52) U.S. Cl. 705/32

(57) ABSTRACT

A system and method for tracking audits of employees is provided. In a simplified embodiment, the system utilizes a memory and a processor programmed by software stored within the memory. The processor is programmed to perform the steps of: requesting a user of the system to specify a number of employed entities to be audited; requesting the user of the system to specify a number of queries to be provided for auditing the employed entities; selecting the specified number of employed entities; requesting the user of the system to provide a job code for each of the selected employed entities to further define the queries that are selected for auditing each of the selected employed entities; and, selecting the specified number of queries for each of the selected employed entities.

### CROSS-REFERENCE TO RELATED APPLICATIONS

This application claims the benefit of and priority to U.S. Provisional Application, Serial No. 60/278,070, filed on Mar. 22, 2001, and entitled “A SYSTEM AND METHOD FOR PROVIDING A COMPUTERIZED AUDIT TRACKING SYSTEM FOR INDUSTRIAL, COMMERCIAL AND OFFICE ENVIRONMENTS,” which is incorporated by reference herein in its entirety.

### FIELD OF THE INVENTION

The present invention generally relates to quality assurance and, more particularly, is related to a system and method for efficiently maintaining quality assurance.

### BACKGROUND OF THE INVENTION

Safety in industrial settings is of great concern to both labor and management. It is important that equipment be maintained to ensure peak performance and proper operation of the equipment, as well as safe operation of the equipment. It is also necessary to properly train both labor and management personnel in operational and safety procedures to maximize industry production and ensure a safe working environment. Quality assurance (i.e., the proper building of products according to specifications) is another application in which it is necessary for manufacturing and safety procedures to be carefully observed and followed.

To accomplish safety and quality assurance goals, management personnel are normally trained to observe, review, and/or correct procedures that are not performed according to accepted or required standards. Correcting observed problems as they occur promotes a working environment that is safe and productive. It should be noted that other environments, such as, but not limited to, commercial establishments and business offices, also require safety and quality assurance procedures.

Audits are typically performed by an auditor who selects a number of employed individuals, such as employees and/or independent contractors, within a specific environment for auditing. The auditor then selects a number of compliance issues on which to test the selected individuals. Questions focused upon determining employee compliance pertaining to their individual employment responsibilities are then asked and answered. These questions also focus upon safety and quality assurance. Results of the audit are then stored within a file cabinet for future review, thereby resulting in a large amount of paperwork that is not easily accessible or even, in some cases, decipherable.

Having information gathered during audits is essential when it is determined that an employee should be dismissed due to non-compliance or commended due to superior performance. In addition, gathered information may be utilized to ensure certain organizational entities, such as, but not limited to, the Food and Drug Administration (FDA), and the Occupational Safety & Health Administration (OSHA), of compliance with implemented regulations. The gathered information may also be utilized to defend companies and/or employees against potential allegations of negligence or liability. As an example, if a company and/or employees of the company are accused of negligence related to an occurrence, the company may utilize gathered information to show that the company and/or employees of the company have properly performed regulatory procedures.

The following is a more specific example demonstrating potential use of gathered information. Rail safety has always been of great concern due to the complex nature of rail systems. Specifically, rail systems have many complex technologies that are required to interact successfully to properly operate trains. Improper use and/or maintenance of technologies utilized within a rail system may lead to extremely dangerous rail conditions. To ensure proper usage and maintenance of rail systems, a series of audits are typically performed on each rail company and its employees, thereby ensuring that employees are knowledgeable of current technologies and procedures pertaining to their individual responsibilities.

It should also be noted that use of customary employee selection procedures to determine who is to be audited results in certain employees never being audited, while other employees may be audited excessively. These circumstances lead to an audit history that is not truly representative of an entire company and that does not assist in determining individual compliance. Therefore, a more efficient and effective auditing system and method are desired to ensure proper compliance with necessary regulations utilized to ensure safety and/or quality assurance.

### SUMMARY OF THE INVENTION

In light of the foregoing, the present invention generally relates to a system for tracing audits of employees. Generally, with reference to the structure of the auditing system, the preferred embodiment of the auditing system, which is merely one embodiment among a plurality of possible embodiments, utilizes a memory and a processor programmed by software stored within the memory. The processor is programmed to perform the steps of: requesting a user of the system to specify a number of employed entities to be audited; requesting the user of the system to specify a number of queries to be provided for auditing the employed entities; selecting the specified number of employed entities; and selecting the specified number of queries for each of the selected employed entities. In one embodiment, the steps of selecting the specified number of employed entities and selecting the specified number of queries may be performed (i.e., selected) randomly. In other embodiments, these selecting steps may be performed pseudo-randomly or non-randomly.

The present invention can also be viewed as providing embodiments employing a method of tracking audits of employed entities. In this regard, the method can be broadly summarized by the following steps: requesting a user of the system to specify a number of employed entities to be audited; requesting the user of the system to specify a number of queries to be provided for auditing the employed entities; selecting the requested number of employed entities; selecting the specified number of queries for each of the selected employed entities; and requesting the user of the system to provide a job code for each of the selected employed entities to further define the queries that may be selected for auditing each of the selected employed entities.

Other systems and methods of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

The invention can be better understood with reference to the following drawings. The components of the drawings are not necessarily to scale, emphasis instead being placed upon clearly illustrating the principles of the present invention. Moreover, in the drawings, like referenced numerals designate corresponding parts throughout the several views.

FIG. 1 is a block diagram illustrating a typical computer or processor-based system wherein auditing software may be provided.

FIG. 2 is a block diagram further illustrating the storage device of FIG. 1.

FIG. 3 is a block diagram further illustrating the security setting table of FIG. 2.

FIG. 4 is a block diagram further illustrating the location table of FIG. 2.

FIG. 5 is a block diagram further illustrating one of the employee tables of FIG. 2.

FIG. 6 is a block diagram further illustrating the job code table of FIG. 2.

FIG. 7 is a flow chart illustrating the architecture, functionality, and operation of a possible implementation of an auditing procedure performed via use of the present auditing system.

FIG. 8 is a flowchart further illustrating functions performed by the auditing software of FIG. 1 if a logged in user has high level security access.

FIG. 9 is an example of a screen display that may be provided to the user, or auditor, when presenting randomly selected employees.

FIG. 10 provides an example of a screen display providing an observation sheet that is provided to a user as a result of selection of a corresponding sheet number.

FIG. 11 is an example of a screen display providing an observations report that may be provided by the auditing software of FIG. 1.

FIG. 12 is an example of a screen display providing a non-compliant report that may be provided by the auditing software of FIG. 1.

FIG. 13 is an example of a screen display providing an incomplete observations report that may be provided by the auditing software of FIG. 1.

FIG. 14 is an example of a screen display providing an employee listing report that may be provided by the auditing software of FIG. 1.

### DETAILED DESCRIPTION

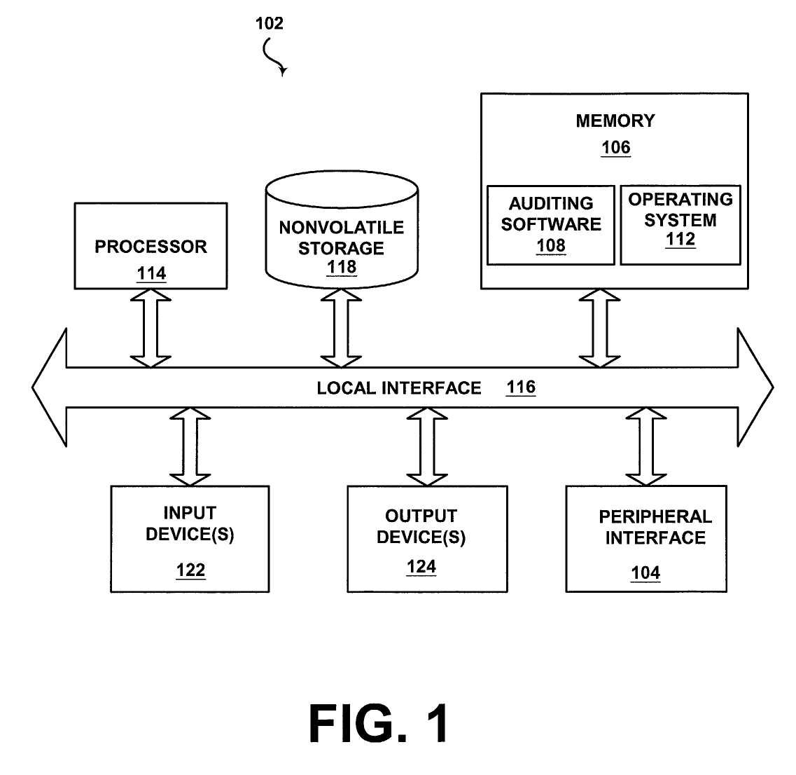

It should also be noted that the present auditing system may be utilized to provide auditing capabilities in fields including, but not limited to, rail systems, hazardous waste facilities, medical facilities, storage warehouses, and manufacturing plants. The individuals audited (i.e., employed entities) may be employees, independent contractors, or any other entity generally employed. Referring now to the drawings, wherein like reference numerals designate corresponding parts throughout the drawings, FIG. 1 is a block diagram illustrating a computer or processor-based system 102 wherein the auditing software may be provided, thereby creating an auditing system 102. Therefore, since the auditing system 102 is the computer system 102 having the auditing software therein, as shown by FIG. 1, the same reference numeral is utilized herein for the computer system 102 and the auditing system 102. As shown by FIG. 1, the computer system 102 has a peripheral interface 104 (e.g., a peripheral component interconnect (PCI) slot) therein. As is known by those of ordinary skill in the art, PCI is an interconnection system between a microprocessor and attached devices in which expansion slots, or PCI slots, are spaced closely for high-speed operation. A PCI card (not shown) may be connected to the peripheral interface 104, thereby allowing communication with attached external devices.

The computer system 102 also comprises a memory 106 where auditing software 108 may be stored. The auditing software 108 describes functionality to be performed in accordance with the present auditing system 102. The computer system 102 may run any of a number of different platforms and operating systems. A nonexhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., PalmOS available from Palm Computing, Inc., and Windows CE available from Microsoft Corporation). Preferably, an operating system 112 utilized by the computer system 102 is also stored within the memory 106. It should be noted that the memory 106 can have a distributed architecture, where various components are situated remote from one another, but can be accessed by a processor.

A nonvolatile storage device 118, such as a hard drive, or optical disk, may also be located within the computer system 102. A processor 114 located within the computer system 102 accepts data and executes instructions from the memory 106, for example, a random access memory, and from the nonvolatile storage device 118 over a local interface 116, such as a bus(es), or a dedicated path. The processor 114 can be any custom made or commercially available processor, a central processing unit (CPU), an auxiliary processor among several processors associated with the computer 102, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc, or a 68xxx series microprocessor from Motorola Corporation. With regard to the preferred embodiment of the invention, the local interface 116, located within the computer system 102, is a PCI bus. Generally, the peripheral interface 104 is attached to the local interface 1116 for providing means for peripheral devices, such as a network interface card (NIC), to attach to the computer system 102.

The computer system 102 may also comprise input device(s) 122 and output device(s) 124. Examples of input devices 122 may include, but are not limited to, a keyboard and a mouse. In addition, examples of output devices 124 may include, but are not limited to, a printer and a computer monitor.

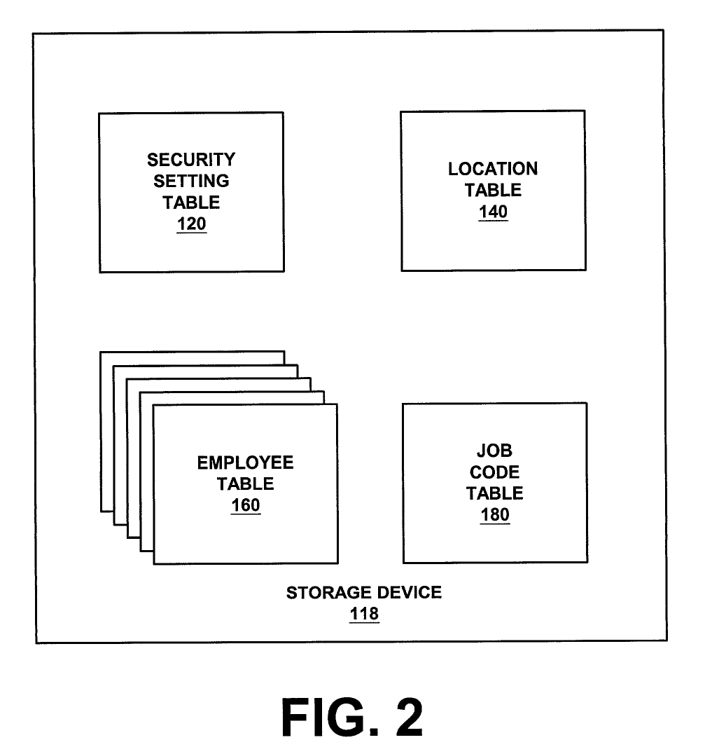

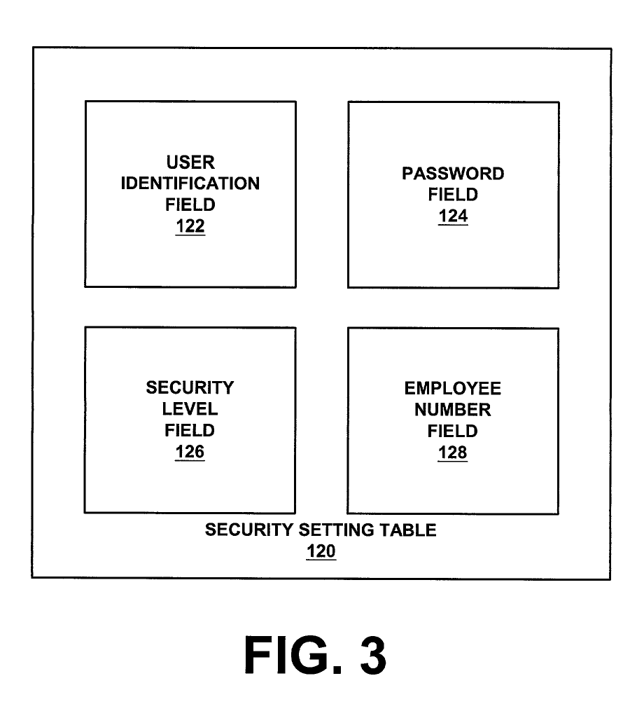

FIG. 2 is a block diagram further illustrating the contents of the nonvolatile storage device 118 of FIG. 1. The nonvolatile storage device 118 comprises a series of lookup tables that are identified in accordance with information stored therein. Specifically, a security setting table 120, a location table 140, a series of employee tables 160, and a job code table 180 are located within the nonvolatile storage device 118. Each of the tables 120, 140, 160, 180 is described in detail below with reference to FIG. 3-FIG. 6. It should be noted that each table 120, 140, 160, 180 comprises a series of fields, each of which is described in detail below. In addition, interaction and requesting of information stored within the tables 120, 140, 160, 180 is further described below.

FIG. 3 further illustrates the security setting table 120 of FIG. 2. The security setting table 120 comprises a user identification field 122 for storing user identifications. The user identification field 122 is preferably limited to a specific number of characters that may be utilized to identify a user, such as an employee or a manager. A password field 124 is also located within the security setting table 120 for storing user passwords that are associated with user identifications. Preferably, one user identification field 122 is associated with one password field 124 so that a user of the auditing system 102 (FIG. 1) is required to provide a user identification and a password prior to use of features made available by the auditing system 102 (FIG. 1).

The security setting table 120 also comprises a security level field 126. The security level field 126 is utilized to store different security levels that are to be assigned to users of the auditing system 102 (FIG. 1). While the user identification and password allow a user to utilize the present auditing system 102 (FIG. 1), security levels may be used to limit user access within the auditing system 102 (FIG. 1).

Titles utilized for the security levels may include low, medium and high levels. In an alternative embodiment, among other possible embodiments, a numerical representation of the levels of security may be utilized. As an example, a security level for an employee may be set to low so that the employee may use the present auditing system 102 (FIG. 1) for viewing finalized and computer inputted audit reports, editing the computer inputted audit reports, entering results from audits, and/or performing audits on employees. Low level security access does not allow editing of data stored within tables 120, 140, 160, 180 of the nonvolatile storage device 118 (FIG. 1).

The security level for a manager that utilizes the auditing system 102 (FIG. 1) may be set to high, thereby allowing the manager to enter, edit and/or manipulate data and reports via use of the auditing system 102 (FIG. 1). Editing, data manipulation, and reports are further discussed in detail below. It should be noted that auditing functions made available for each separate level of security may differ and be changed by a user having the highest security level.

An employee number field 128 may also be located within the security setting table 120. The employee number field 128 provides a location for storage of an employee identification that may be used for assigning security levels for employees. As an example, the employee number field 128 may store the last four digits of an employee social security number or an employee number from a time sheet.

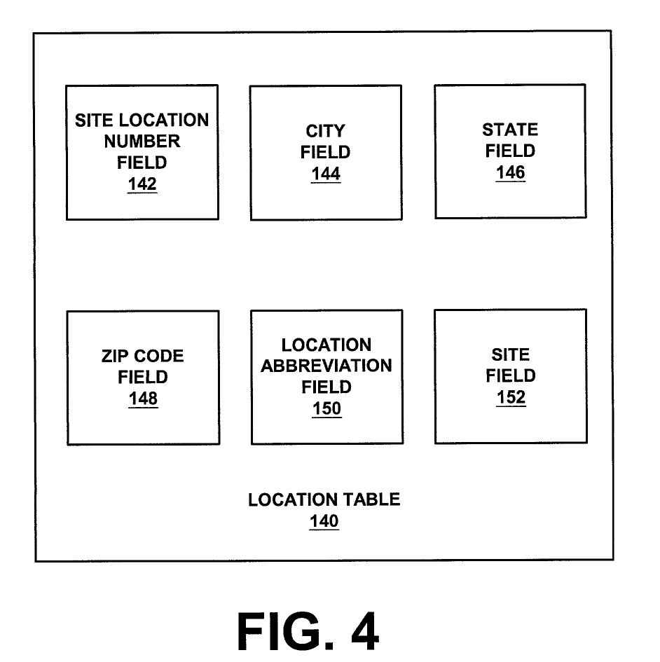

FIG. 4 further illustrates the location table 140 of FIG. 2. The location table 140 comprises a site location number field 142. The site location number field 142 stores site numbers assigned to different locations that utilize the present auditing system 102 (FIG. 1). Examples of locations may include a chemical storage facility, a manufacturing plant, or any other location where usage of the auditing system 102 (FIG. 1) would be useful. Preferably, each different site location that may use the present auditing system (FIG. 1) is assigned a site number for identification within the auditing software 108 (FIG. 1).

A city field 144, a state field 146 and a zip code field 148 are also located within the location table 140 for further defining the location of the site. A location abbreviation field 150 located within the location table 140 stores abbreviations that represent the site where audits are to be performed, or the location where people to be audited are working. As an example, if the site is located in New York, the location abbreviation field 150 may have the value “NY” stored therein.

A site field 152 is also located within the location table 140 for storing abbreviations used by the auditing software 108 (FIG. 1) to represent locations within the site that are to be audited. Examples of locations within a site may include, but are not limited to, a wash rack area, a warehouse area, a stock room area, and/or a loading dock area. Of course, the full name of the location may be stored within the site field instead of an abbreviation. Other fields may also be located within the location table 140 including, but not limited to, a work phone field, a facsimile (fax) number field, a contact person field and a phone extension of the contact person field. In fact, any information that is beneficial in further identifying a site where the auditing system 102 (FIG. 1) is implemented may be stored within respective fields.

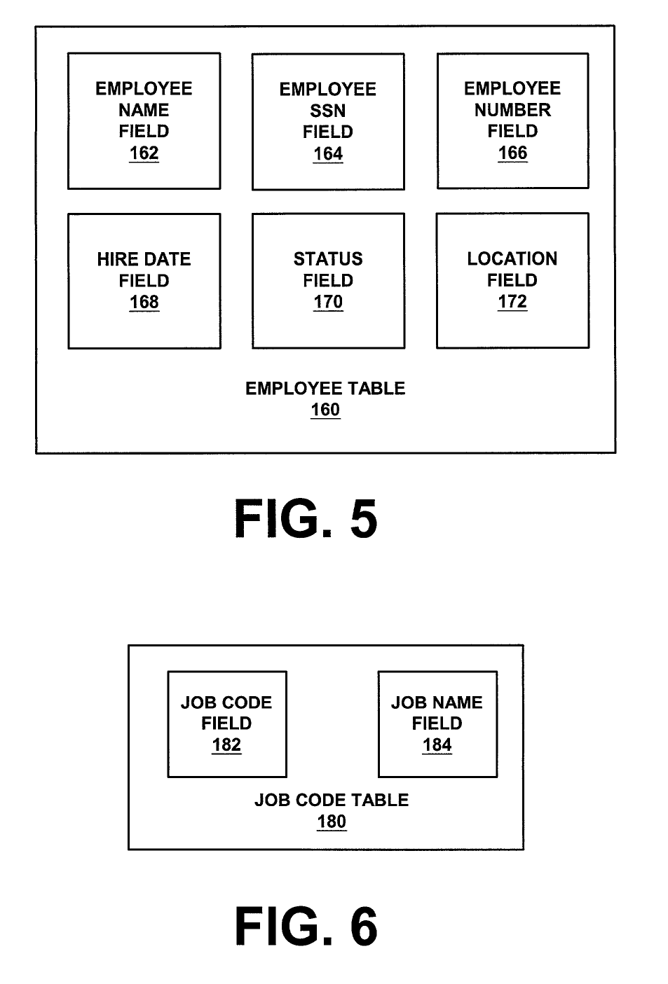

FIG. 5 further illustrates one of the employee tables 160 of FIG. 2. Information stored within a single employee table 160 preferably refers to a single employee. Therefore, a series of employee tables are located within the nonvolatile storage device 118 (FIG. 1), so as to identify numerous employees that are subject to being audited via use of the present auditing system 102 (FIG. 1). For simplicity purposes, the following describes a single employee table 160.

The employee table 160 comprises an employee name field 162 for identifying the name of the employee that is subject to being audited via use of the auditing system 102 (FIG. 1). Preferably, a first and last name of the employee is required. A middle initial may also be stored within the employee name field 162. The employee table 160 also comprises an employee social security number (SSN) field 164 for storing a social security number of an employee. It should be noted that another employee identifier may be used instead of, or in addition to, an employee SSN. The last four digits of the social security number are stored within an employee number field 166. The employee number field 166 located within the employee table 160 is the same as the employee number field 128 located within the security settings table 120 (FIG. 3). Other employee identifying fields may include, for example, an address field, a phone number field, and a birth date field (not shown).

A hire date field 168 is also located within the employee table 160 for storing the date that an employee was hired. In addition, a status field 170 stores the working status of the employee. Examples of values that may be used within the status field 170 include, “A” for active, “L” for leave of absence, “R” for retired, “S” for sick leave, “T” for terminated, and “VT” for voluntary termination.

The employee table 160 also comprises a location field 172 for storing potential employee physical work locations. In fact, the potential employee physical work locations are the same locations as those stored within the site field 152 of the location table 140 (FIG. 4).

FIG. 6 further illustrates the job code table 180 of FIG. 2. A job code field 182 is located within the job code table 180 wherein identifications of specific jobs are stored. Examples of job identifications may include, but are not limited to, fork lift operator, high lift operator, and control operator. It should be noted that abbreviations may be used for the job identifications, examples of which include “FLO,” “HLO,” and “CO,” which relate to the identifications fork lift operator, high lift operator, and control operator respectively.

A job name field 184 is also located within the job code table 180. The job name field 184 stores queries referring to specific tasks that are performed by an employee. Specifically, each job performed by an employee requires certain actions to be taken in order to remain in compliance with certain regulatory standards. As an example, OSHA may require a fork lift operator in a chemical plant to use rubber-soled shoes while operating a fork lift. As a result, the job name field 184 may comprise a query that asks if the employee used rubber-soled shoes while operating the fork lift.

Therefore, queries provide a means for determining compliance with regulatory standards for safety and/or quality assurance. The auditing system 102 (FIG. 1) provides a manner for utilizing the queries to efficiently audit employees, and for easily presenting results of audits. The following describes a procedure for auditing employees via use of the present auditing software 108 (FIG. 1).

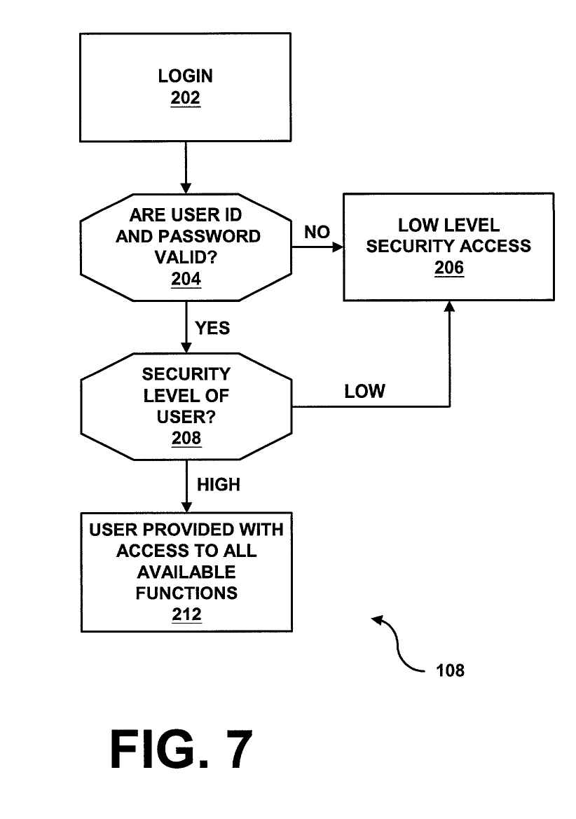

FIG. 7 is a flow chart illustrating the architecture, functionality, and operation of a possible implementation (non-limiting example) of an auditing procedure performed via use of the present auditing system 102 (FIG. 1). With regard to all flow charts provided herein, each block represents a module, segment, or portion of code, which comprises one or more executable instructions for implementing the specified logical function(s). It should also be noted that in some alternate implementations, the functions noted in the blocks may occur out of the order noted. For example, two blocks shown in succession may in fact be executed substantially concurrently, or the blocks may sometimes be executed in the reverse order, depending upon the functionality involved.

As shown by block 202, an individual intending to use the auditing system 102 (FIG. 1) is required to log into the auditing system 102 (FIG. 1) prior to being able to use features made available by the auditing software 108 (FIG. 1). Logging into the auditing system 102 (FIG. 1) may be performed by the user entering a user identification and a password via one of the input devices 122 (FIG. 1) connected to the computer 102 (FIG. 1). In fact, entry of other material for the auditing software 108 (FIG. 1) may also be provided by a user via an input device 122, such as, but not limited to, a keyboard.

Validity of the user identification and password is then determined (block 204) by the processor 114 (FIG. 1) searching the security setting table 120 (FIG. 3) for the provided user identification and password. It should be noted that the user may choose to bypass the login process. Bypassing of the login process results in availability of the same functions as those functions made available if the user identification and password are not valid.

As shown by block 206, if the user identification and password are not valid, the user is allowed low level security access to features made available by the auditing software 108 (FIG. 1). Low level security access allows the user to utilize the present auditing system 102 (FIG. 1) for viewing finalized and computer inputted audit reports, editing the computer inputted audit reports, entering results from completed audits performed via use of observation sheets, and performing audits. Observation sheets are forms that are created and used by the auditing system 102 (FIG. 1) to perform random employee auditing. Further discussion of the production and use of observation sheets is provided in detail below. Low level security access does not allow editing of data stored within tables 120, 140, 160, 180 of the nonvolatile storage device 118 (FIG. 1).

If the user identification and password are valid, the processor 114 (FIG. 1) determines the security access level assigned to the logged in user (block 208) by searching for the security level associated with the inputted user identification and password within the security setting table 120 (FIG. 3). If the user is assigned low level security access, then the user is allowed to perform the low level security access functions mentioned above (block 206). The following assumes, for simplicity of description, that the logged in user has been assigned high level security access that allows access to all features made available by the auditing software (block 212). Of course, other levels of security access may be provided wherein different selected functions made available by the auditing software 108 (FIG. 1) may be assigned to the different levels of security access.

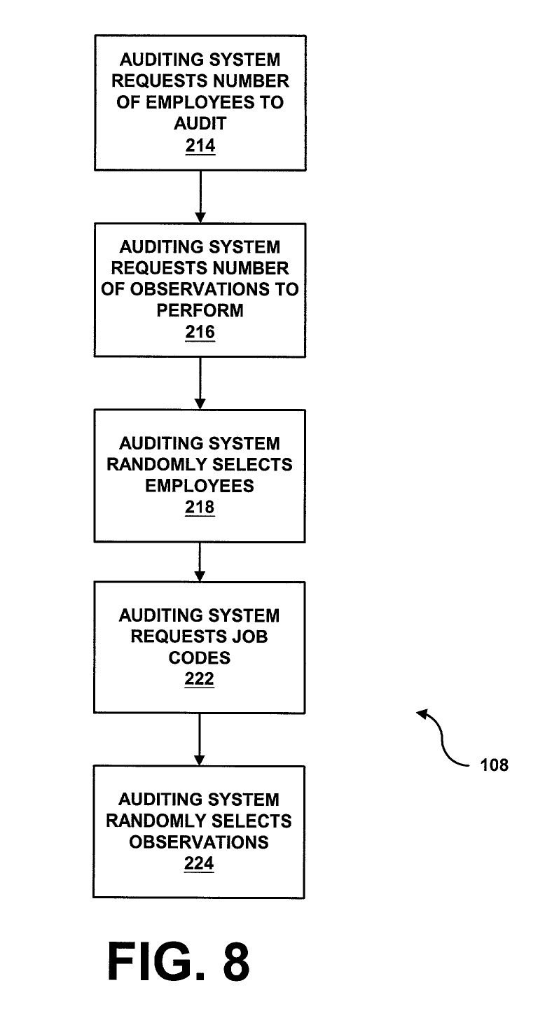

FIG. 8 is a flowchart that further illustrates functions performed by the auditing system 102 (FIG. 1) if a logged in user has high level security access. When the user is logged into the auditing system 102 (FIG. 1), the auditing system 102 (FIG. 1) provides the user with a request for a number of employees to audit (block 214). In addition, the auditing system 102 (FIG. 1) provides the user with a request for a number of observations to be performed on each employee (block 216). It is also preferred that the auditing system 102 (FIG. 1) request entry of the name of the user, thereby providing a method of tracking the names of individuals performing audits.

After the user has entered the number of employees to audit and the number of observations to be performed, the processor 114 (FIG. 1) randomly selects the requested number of employees to audit by randomly selecting a number of employee tables 160 (FIG. 5) from the nonvolatile storage device 118 (FIG. 1). It should be noted that random selection may be performed via use of any known method of randomizing selection, including, but not limited to, use of randomizing algorithms. The number of selected employee tables 160 (FIG. 5) is equal to the user specified number of employees (block 218). In other embodiments, not specifically illustrated, the “selection” may be made pseudo-randomly or non-randomly.

The auditing system 102 (FIG. 1) then provides the user, or auditor, with the first of the randomly selected employees and requests a job code to be entered for the first randomly selected employee (block 222). An entered job code is required to match one of the job identifications stored within the job code field 182. Job codes are then sequentially required to be entered for each of the randomly selected employees until all employees have been associated with a job code. It should be noted that, in accordance with one alternative embodiment of the invention, more than one job code may be requested if employees that are to be audited tend to work on more than one specific job.

In accordance with another alternative embodiment of the invention, a job code field may be provided within each employee table 160 (FIG. 5) to alleviate the need for requesting specification of a job code for each of the randomly selected employees. Providing a job code field within each employee table 160 is desirable in a location where employees are responsible for one specific job, such as, but not limited to, within a line assembly manufacturing plant.

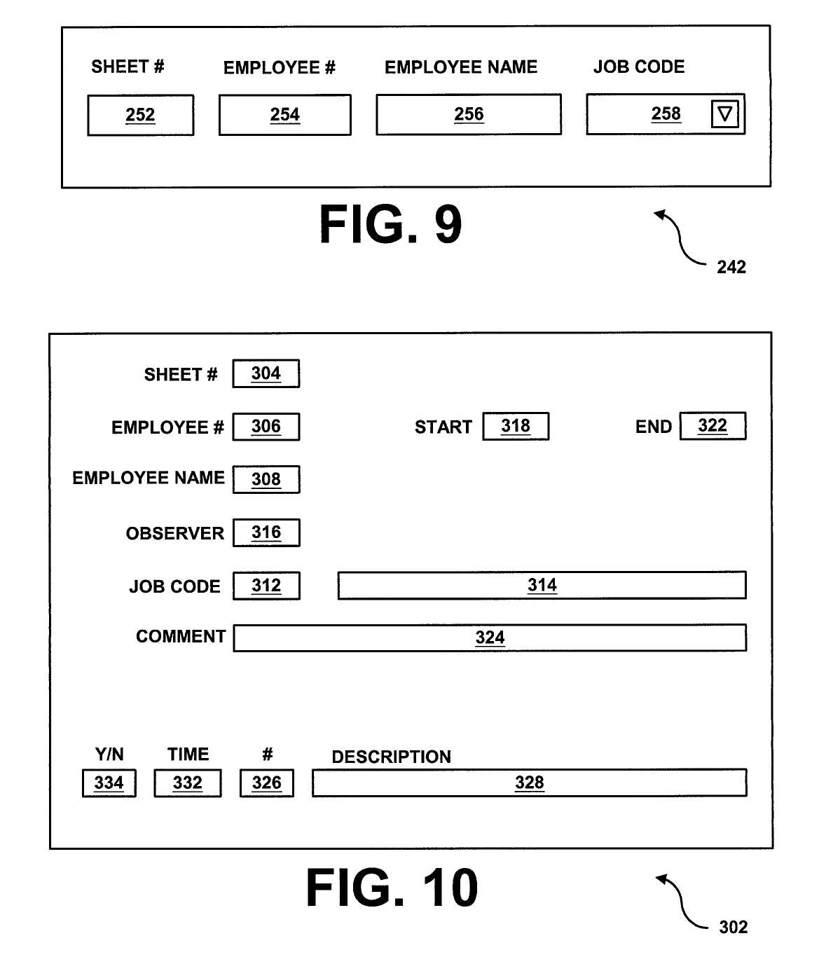

FIG. 9 is an example of a screen display 242 that may be provided to the user, or auditor, when presenting the randomly selected employees (block 222). As shown by FIG. 9, the screen display 242 comprises a sheet number column 252, an employee number column 254, an employee name column 256, and a job code column 258. Each row shown within the screen display 242 comprises one sheet number, one employee number, one employee name, and a pull-down menu for selecting one job code. Each employee name and number pair located within a row are received from one of the randomly selected employee tables 160 (FIG. 5). The sheet number is a number that identifies an observation sheet that is created by the auditing software 108 (FIG. 1), wherein the observation sheet comprises one randomly selected employee, the user-specified number of observations to be performed on the employee, a location for indicating compliance or non-compliance with each of the randomly selected observations, and a location for specifying the date when the observation was performed. Observation sheets are further discussed below.

Returning to FIG. 8, after specification of job codes for each of the randomly selected employees (block 222), the processor 114 (FIG. 1) randomly selects the specified number of observations to be performed (block 224). The selected observations are selected for each randomly selected employee by randomly selecting from the queries stored within the job name field 184 (FIG. 6) that are associated with the job code entered for each employee. Any known method of performing random selection may be used.

With completion of information gathering, observation sheets may be printed to determine compliance or non-compliance of each randomly selected employee with the randomly selected observations. It is preferred that each observation sheet has a single sheet number. Providing a single observation sheet for a single employee simplifies observation of compliance and recording of results after observation.

After observation compliance or non-compliance has been determined, results are stored for use by the auditing software 108 (FIG. 1) by the user inputting the results via use of the input devices 122 (FIG. 1). To store the results the user, or auditor, may select the sheet number of the observation sheet from a pull-down list provided by the auditing system 102 (FIG. 1). Selection of the sheet number provides the user with a corresponding electronically displayed observation sheet where compliance and/or non-compliance with queries may be recorded. FIG. 10 provides an example of an observation sheet provided to a user as a result of selection of a corresponding sheet number.

As shown by FIG. 10, the displayed observation sheet 302 displays the sheet number 304 associated with the observation sheet 302. Employee information is also displayed by the observation sheet 302, including the identification number of the employee 306 and the name of the employee 308. It should be noted that the employee information located within the displayed observation sheet 302 can be, and is typically, the same employee information previously stored within an employee table 160 (FIG. 5). The job code 312 previously entered for the employee is also displayed by the observation sheet 302, as well as a description 314 associated with the job code (i.e., crew leader).

The name 316 of the individual who performed the observation is also displayed within the observation sheet 302, as well as the date 318 when the observation sheet 302 was first called by the auditing software 108 (FIG. 1). Herein, the first called date is the date when the auditing software 108 (FIG. 1) first created the observation sheet 302. An end date of observation 322 is displayed within the observation sheet 302, wherein the end date is the date that results received after auditing, via use of the observation sheet 302, are inputted into the computer 102 (FIG. 1). It should be noted that the end date of the observation sheet may read “incomplete” if results recorded by a user have not been entirely inputted into the computer 102 for use by the auditing software 108 (FIG. 1). If the user has comments regarding the audited employee, the user may enter the comments within a comment section 324 of the displayed observation sheet 302.

The observation sheet 302 also indicates the selected observations that were previously randomly selected for the employee in accordance with a specified job code. A job identification section 326 and a job query section 328 for each observation are provided within the observation sheet 302. An observation time section 332 is provided adjacent to the job identification section 326 for specification of the time when the observation query was answered by the user. A compliance section 334 is provided adjacent to the observation time section 332 to allow the user to specify whether the employee complied with a specific job query.

It should be noted that the auditing software 108 (FIG. 1) allows observation sheets to be edited multiple times; however, a record of previous observations is stored within the nonvolatile storage device 118 (FIG. 1). In addition, when a change is made to a stored observation sheet, the time of the change is recorded, as well as the name of the observer that performs the change.

The auditing system 102 (FIG. 1) of the present invention can be implemented in software, firmware, hardware, or a combination thereof. In the above-described preferred embodiment of the invention, which is intended to be a non-limiting example, a portion of the auditing system 102 (FIG. 1) is implemented in software 108 (FIG. 1) that is executed by a computer 102 (FIG. 1), for example, but not limited to, a server, a personal computer, work station, minicomputer, or main frame computer.

The software based portion of the auditing system 102 (FIG. 1), which comprises an ordered listing of executable instructions for implementing logical functions, can be embodied in any computer-readable medium for use by, or in connection with, an instruction execution system, apparatus, or device such as a computer-based system processor containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus or device.

The computer-readable medium can be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disk read-only memory (CD ROM) (optical). Note that the computer-readable medium could even be paper or another suitable medium upon which the program is printed, as the program can be electronically captured, via for instance, optical scanning of the paper or other medium, then compiled, interpreted or otherwise processed in a suitable manner, if necessary, and then stored in a computer memory.

It should be noted that the auditing system 102 (FIG. 1) may also be implemented via hardware. If implemented in hardware, as in an alternative embodiment, functions performed by the auditing software 108 (FIG. 1) can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Reports may be printed or viewed after the auditing software 108 (FIG. 1) creates at least one observation sheet. The reports may be printed or viewed in accordance with different criteria, examples of which are described below. It should be noted that each of the following reports do not necessarily require all elements described herein. Instead, the report may comprise fewer or more elements therein.

One report made available via the auditing software 108 (FIG. 1) is a completed observations report. The completed observations report provides a report based upon observation sheets that have been entirely completed, including specification of compliance and non-compliance with queries, and wherein observation sheet results have been inputted into the computer 102 (FIG. 1) for use by the auditing software 108 (FIG. 1).

A completed observations report comprises individual completed observation sheets, wherein each completed observation sheet of the preferred embodiment comprises the following: the observation sheet number; the name of the observer; the name of the employee audited; the identification number of the employee; the location of the site where the employee was audited; a description of the job queried, defined by a job code; a start date of the audit; an end date of the audit; the time when the audit was performed; whether the employee was compliant with each observation; and the observation query asked.

Another report made available via the auditing software 108 (FIG. 1) is a compliant observations report. The compliant observations report provides a report summarizing observation queries with which an employee was compliant, based upon completed and electronically inputted observation sheets.

A compliant observations report is sorted by individual completed observation sheets, wherein each compliant observations report of the preferred embodiment comprises the following: the observation sheet number; the name of the observer; the name of the employee audited; the identification number of the employee; the location of the site where the employee was audited; a description of the job queried, defined by a job code; a start date of the audit; an end date of the audit; the time when the audit was performed; specification that the employee was compliant with each observation; and the observation query asked.

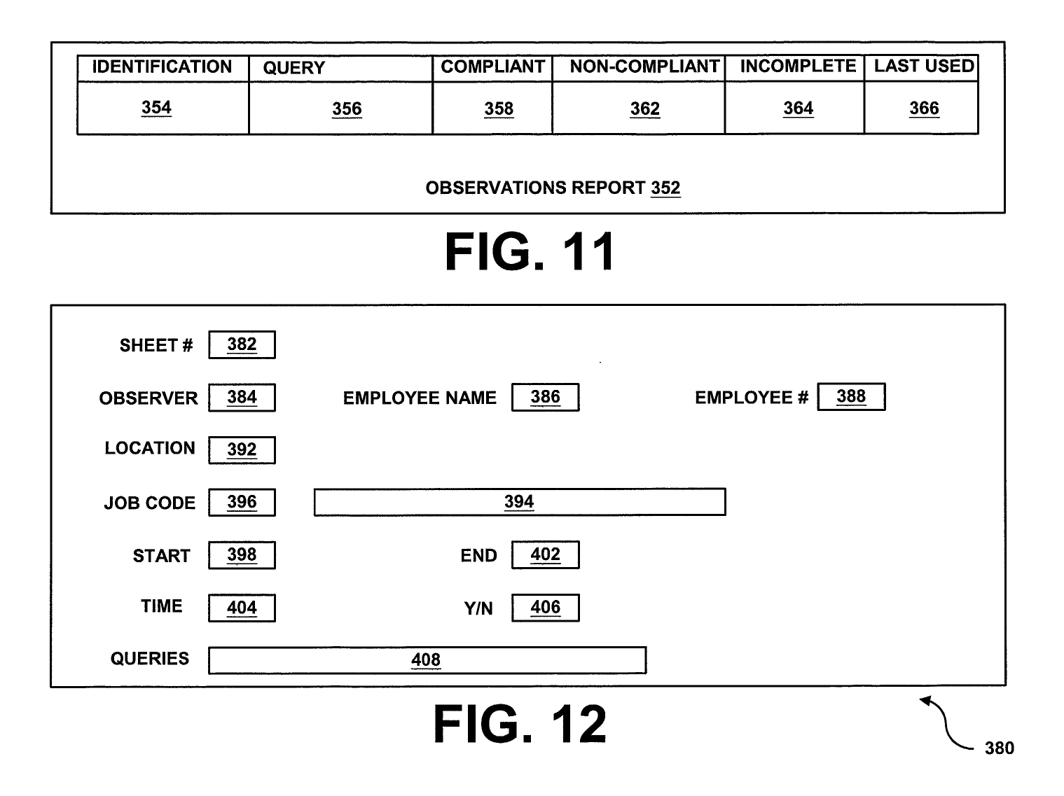

An observations report is made available by the auditing software 108 (FIG. 1). The observations report summarizes usage of observation queries stored within the job name field 184 (FIG. 6). FIG. 11 is an example of an observations report 352. Specifically, the observations report 352 comprises the following: a job identification column 354; an associated job query column 356; a compliant column 358 for providing a summary of the number of times employees have been in compliance with a job query; a non-compliant column 362 for providing a summary of the number of times employees have not been in compliance with a job query; an incomplete column 364 for summarizing the number of times a job query was randomly selected for an observation sheet, wherein results of an audit performed via use of the observation sheet have not yet been inputted to the auditing system 102 (FIG. 1); and, a last used date column 366 for providing the last date that a job query was randomly selected.

The observations report may serve multiple purposes. As an example, federal regulations sometimes require random drug testing of employees. A factory wishing to be in compliance with such federal regulations can create a job query asking whether an employee was compliant with drug regulations when subjected to drug testing. Since employees are randomly selected by the auditing software 108 (FIG. 1), as are job queries, the auditing software 108 (FIG. 1) provides a method for complying with federal drug regulations. In addition, the observations report provides proof of compliance with federal drug regulations.

A non-compliant observations report 380 is made available by the auditing software 108 (FIG. 1), an example of which is provided by FIG. 12. The non-compliant observations report 380 provides a report summarizing observation queries with which an employee was not compliant, based upon completed and electronically inputted observation sheets.

A non-compliant observations report 380 is sorted by individual completed observation sheets, wherein each non-compliant observations report 380 of the preferred embodiment comprises the following: the observation sheet number 382; the name of the observer 384; the name of the employee audited 386; the identification number of the employee 388; the location of the site where the employee was audited 392; a description of the job queried 394, defined by a job code 396; a start date of the audit 398; an end date of the audit 402; the time when the audit was performed 404; specification that the employee was not compliant with each observation 406; and, the observation queries asked 408.

A security level report is also made available by the auditing software 108 (FIG. 1). The security level report provides a summary of security levels, a description of access associated with each security level and a list of user identifications associated with each particular security level.

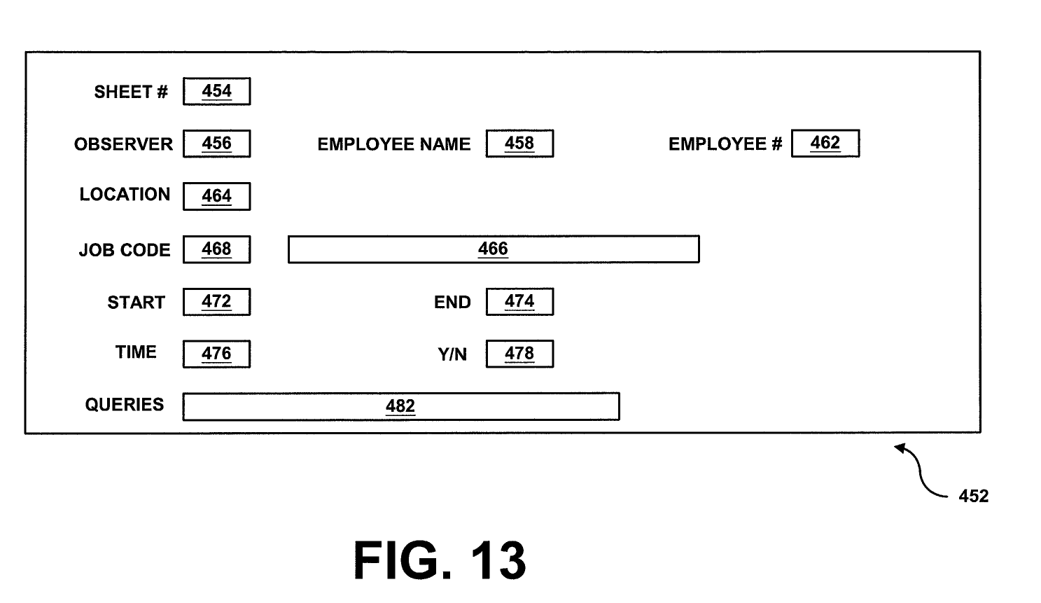

An incomplete observations report 452 may be provided by the auditing software 108 (FIG. 1), an example of which is provided by FIG. 13. The incomplete observations report 452 of the preferred embodiment comprises individual incomplete observation sheets, wherein each incomplete observation sheet comprises the following: the observation sheet number 454; the name of the observer 456; the name of the employee to be audited 458; the identification number of the employee 462; the location of the site where the employee is to be audited 464; a description of the job to be queried 466, defined by a job code 468; a start date of the audit 472, namely, the date of creation of the observation sheet; an end date of the audit 474, which is blank since this is an incomplete observations report; the time when the audit was performed 476, which is blank since this is an incomplete observations report; whether the employee was compliant with each observation 478, which is blank since this is an incomplete observations report; and, the observation query asked 482.

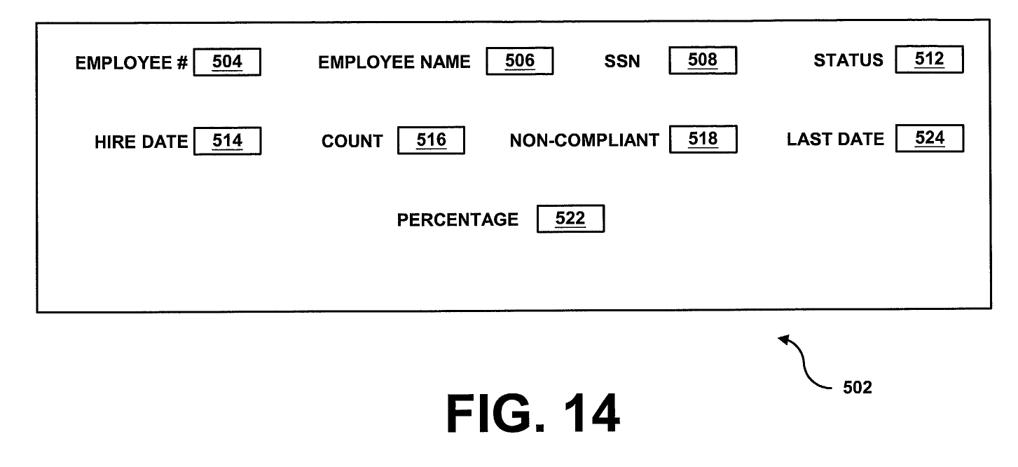

In addition, an employee listing report 502 may be provided by the auditing software 108 (FIG. 1), an example of which is provided by FIG. 14. The employee listing report provides a summary of activities pertaining to each individual employee and is sorted either by employee number or by employee name. As shown by FIG. 14, the employee listing report 502 comprises an employee number column 504 and an employee name column 506. The social security number of the employee 508 may also be provided within the employee listing report 502. A status column 512 and a hire date column 514 further define the employee within the employee listing report 502.

Observation data is also located within the employee listing report 502 comprising, in the preferred embodiment: a count column 516 for providing a summary of the number of queries that have been randomly selected for the employee; a non-compliant column 518; a percentage of non-compliance column 522; and a last observed date column 524 for specifying when the employee was last audited.

It should be noted that other reports may also be provided by the auditing software 108 (FIG. 1). As an example, graphs may be produced illustrating compliance trends within a location, or compliance trends by an employee.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

At least the following is claimed:

1. A system for tracking audits of employed entities, comprising:
a memory; and,
a processor programmed by software stored within said memory to perform the steps of:
requesting a user of said system to specify a number of employed entities to be audited;
requesting said user of said system to specify a number of queries to be provided for auditing said employed entities;
selecting said specified number of employed entities; and
selecting said specified number of queries for each of said selected employed entities.

2. The system of claim 1, wherein said step of selecting said specified number of employed entities further comprises random selection of said specified number of employed entities, and wherein said step of selecting said specified number of queries further comprises random selection of said specified number of queries for each of said randomly selected employed entities.

3. The system of claim 2, wherein one of said randomly selected employed entities and said queries that were randomly selected for said one of said randomly selected employed entities are provided within an observation sheet, wherein said observation sheet may be utilized to audit said one of said randomly selected employed entities.

4. The system of claim 3, wherein results from auditing said one of said randomly selected employed entities are stored by said user within a storage device located within said system, said results being accessible via reports made available by said system.

5. The system of claim 3, wherein said observation sheet further comprises a location for designating compliance and non-compliance of said one of said randomly selected employed entities with said randomly selected queries.

6. The system of claim 2, wherein said processor is further programmed by said memory to perform the step of requesting said user of said system to provide a job code for each of said randomly selected employed entities to further define said queries that are selected for auditing each of said randomly selected employed entities.

7. The system of claim 6, wherein said specified number of employed entities and said specified number of queries are selected from a storage device and wherein permission to change information located within said storage device is determined by a security level assigned to said user.

8. A computer readable medium having a computer program for tracking audits, comprising:
a first routine that requests a user of said computer program to specify a number of employed entities to be audited;
a second routine that requests said user of said system to specify a number of queries to be provided for auditing said employed entities;
a third routine that selects said specified number of employed entities; and
a fourth routine that selects said specified number of queries for each of said selected employed entities.

9. The computer readable medium of claim 8, wherein said third routine randomly selects said specified number of employed entities and wherein said fourth routine randomly selects said specified number of queries for each of said randomly selected employed entities.

10. The computer readable medium of claim 9, wherein said computer program further comprises a fifth routine for providing one of said randomly selected employed entities and said queries that were randomly selected for said one of said randomly selected employed entities within an observation sheet, wherein said observation sheet may be utilized to audit one of said randomly selected employed entities.

11. The computer readable medium of claim 10, wherein said observation sheet further comprises a location for designating compliance and non-compliance of said one of said randomly selected employed entities with said randomly selected queries.

12. The computer readable medium of claim 9, wherein said computer program further comprises a fifth routine that requests said user of said system to provide a job code for each of said randomly selected employed entities to further define said queries that are selected for auditing each of said randomly selected employed entities.

13. The computer readable medium of claim 12, wherein said specified number of employed entities and said specified number of queries are selected from a storage device and wherein permission to change information located within said storage device is determined by a security level assigned to said user.

14. A system for tracking audits of employed entities, comprising:
means for requesting a user of said system to specify a number of employed entities to be audited;
means for requesting said user of said system to specify a number of queries to be provided for auditing said employed entities;
means for selecting said specified number of employed entities; and
means for selecting said specified number of queries for each of said selected employed entities.

15. The system of claim 14, wherein said means for selecting said specified number of employed entities randomly selects said specified number of employed entities, and wherein said means for selecting said specified number of queries for each of said selected employed entities randomly selects said specified number of queries for each of said randomly selected employed entities.

16. The system of claim 15, wherein said means for randomly selecting said specified number of employed entities and said means for randomly selecting said specified number of queries are software located in a memory of a computer.

17. The system of claim 15, wherein said means for randomly selecting said specified number of employed entities and said means for randomly selecting said specified number of queries are hardware.

18. The system of claim 15, wherein one of said randomly selected employed entities and said queries that were randomly selected for said one of said randomly selected employed entities are provided within an observation sheet, wherein said observation sheet may be utilized to audit said one of said randomly selected employed entities.

19. The system of claim 18, wherein results from auditing said one of said randomly selected employed entities are stored by said user within a storage device located within said system, said results being accessible via reports made available by said system.

20. The system of claim 18, wherein said observation sheet further comprises a location for designating compliance and non-compliance of said one of said randomly selected employed entities with said randomly selected queries.

21. The system of claim 15, further comprising means for requesting said user of said system to provide a job code for each of said randomly selected employed entities to further define said queries that are selected for auditing each of said randomly selected employed entities.

22. The system of claim 21, wherein said specified number of employed entities and said specified number of queries are selected from a means for storing and wherein permission to change information located within said means for storing is determined by a security level assigned to said user.

23. A method of tracking audits of employed entities, comprising the steps of:
requesting a user of said method to specify a number of employed entities to be audited;
requesting said user of said method to specify a number of queries to be provided for auditing said employed entities;
selecting said specified number of employed entities; and
selecting said specified number of queries for each of said selected employed entities.

24. The method of claim 23, wherein said step of selecting said specified number of employed entities further comprises random selection of said specified number of employed entities, and wherein said step of selecting said specified number of queries for each of said selected employed entities further comprises random selection of said specified number of queries for each of said randomly selected employed entities.

25. The method of claim 24, wherein one of said randomly selected employed entities and said queries that were randomly selected for said one of said randomly selected employed entities are provided within an observation sheet, wherein said observation sheet may be utilized to audit said one of said randomly selected employed entities.

26. The method of claim 25, wherein results from auditing said one of said randomly selected employed entities are stored by said user within a storage device, said results being accessible via reports made available by said method.

27. The method of claim 25, wherein said observation sheet further comprises a location for designating compliance and non-compliance of said one of said randomly selected employed entities with said randomly selected queries.

28. The method of claim 24, further comprising the step of requesting said user of said method to provide a job code for each of said randomly selected employed entities to further define said queries that are selected for auditing each of said randomly selected employed entities.

29. The method of claim 28, wherein said specified number of employed entities and said specified number of queries are selected from a storage device and wherein permission to change information located within said storage device is determined by a security level assigned to said user.

30. A system for tracking audits of employed entities, comprising:
a memory; and,
a processor programmed by software stored within said memory to perform the steps of:
requesting a user of said system to specify a number of employed entities to be audited;
requesting said user of said system to specify a number of queries to be provided for auditing said employed entities;
selecting said specified number of employed entities via use of an algorithm; and
selecting said specified number of queries for each of said selected employed entities via use of an algorithm.
